(19) United States
(12) Patent Application Publication
(10) Pub. No.: US 2014/0111734 A1
(43) Pub. Date: Apr. 24, 2014

(54) PRINTED CIRCUIT BOARD STRUCTURE OF BACKLIGHT UNIT, BACKLIGHT UNIT AND LIQUID CRYSTAL DISPLAY DEVICE USING THE SAME

(71) Applicants: Chong Xiong, Shenzhen (CN); Lindong Fang, Shenzhen (CN); Kuangyao Chang, Shenzhen (CN); Weiyan Wei, Shenzhen (CN)

(72) Inventors: Chong Xiong, Shenzhen (CN); Lindong Fang, Shenzhen (CN); Kuangyao Chang, Shenzhen (CN); Weiyan Wei, Shenzhen (CN)

(73) Assignee: SHENZHEN CHINA STAR OPTOELECTRONICS tECHNOLOGY CO., LTD., Shenzhen, Guangdong (CN)

(21) Appl. No.: 13/812,091

(22) PCT Filed: Oct. 29, 2012
(86) PCT No.: PCT/CN2012/083678

§ 371 Date: Jan. 24, 2013

(30) Foreign Application Priority Data
Jun. 11, 2012 (CN) 201210190687.0

(51) Int. Cl. F21V 21/00; G02F 1/1335; G02F 1/1333

(52) U.S. Cl. CPC F21V 21/00; G02F 1/133308; G02F 1/133603
USPC 349/58; 174/250; 362/97.3

(57) ABSTRACT

A printed circuit board structure of a backlight unit is provided, which comprises a circuit board, having a first and a second lateral side corresponding to the first lateral side, wherein the first lateral side has a first notch and the second lateral side has a second notch. In addition, a backlight unit is provided, which comprises a back plate, a circuit board, and a plurality of LEDs. The circuit board is disposed on the back plate, wherein the circuit board has a first and a second lateral side corresponding to the first lateral side, the first lateral side has a first notch, and the second lateral side has a second notch disposed on a surface of the circuit board. A plurality of LEDs is disposed on the circuit board. Furthermore, a backlight unit of a liquid crystal display device is provided, which comprises a printed circuit board structure.

### BACKGROUND OF THE INVENTION

1. Field of Invention

The present invention relates to a printed circuit board structure, and more particularly to a first lateral side and a second lateral side of a printed circuit board structure of a backlight unit respectively having a notch, the backlight unit and the liquid crystal display device using the same.

2. Related Art

In the liquid crystal display device, a backlight unit provides mainly a light source to a liquid crystal panel, such that the liquid crystal display device can display images. Wherein, the backlight unit usually comprises a back plate, a printed circuit board (hereafter to be referred as a circuit board), and a plurality of light emitted diodes.

Specifically, the circuit board is disposed on the back plate and is further disposed with a plurality light emitted diodes thereon. However, in the conventional backlight unit (i.e., a direct type backlight unit), a bar-shaped circuit board is mostly used for disposing the light emitted diodes thereon, such that the material cost of the circuit board is increased. In addition, a heat dissipation efficiency of the light emitted diode is also limited due to the structure of the bar-shaped circuit board (i.e., length and/or width).

As shown in FIG. 1, FIG. 1 illustrates a conventional L-shaped circuit board. The circuit board 60 is an L shape in FIG. 1. Most of thermal energy generated (as shown by the arrow) from a plurality of light emitted diodes 600 disposed on the circuit board 60 is dissipated via a lateral path of the circuit board 60 in FIG. 1, so that the heat dissipation efficiency is limited.

### SUMMARY OF THE INVENTION

The present invention provides a printed circuit board structure of a backlight unit, a backlight unit, and a liquid crystal display device using the same.

According to above-mentioned objective, a printed circuit board structure of a backlight unit provided by the present invention comprises a circuit board, wherein the circuit board has a first lateral side and a second lateral side corresponding to the first lateral side, and the first lateral side has a first notch and the second lateral side has a second notch.

The printed circuit board structure of the backlight unit provided by an embodiment of the present invention further comprises: the position of the first notch is corresponding to the position of the second notch; the first notch is plural notches and the second notch is plural notches; and the length of the first wing piece is equal to the length of the second wing piece.

A backlight unit provided by the present invention comprises a back plate, a circuit board, and a plurality of light emitted diodes. The circuit board is disposed on the back plate, wherein the circuit board has a first lateral side and a second lateral side corresponding to the first lateral side, the first lateral side has a first notch, the second lateral side has a second notch, and a plurality of light emitted diodes is disposed on a surface of the circuit board.

The backlight unit provided by an embodiment of the present invention further comprises the first notch is located on the position corresponding to the position of the second notch; the first lateral side has a plurality of the first notches, and the second lateral side has a plurality of the second notches; the first lateral side and the second lateral side through the first notch and the second notch respectively form a first wing piece and a second wing piece, and the length of the first wing piece is equal to the length of the second wing piece.

A liquid crystal display device provided by an embodiment of the present invention comprises a backlight unit and a liquid crystal panel. The backlight unit comprises a back plate, a circuit board disposed on the back plate, a plurality of light emitted diode, wherein the circuit board has a first lateral side and a second lateral side corresponding to the first lateral side, the first lateral side has a first notch, and the second lateral side has a second notch, a plurality of light emitted diodes is disposed on a surface of the circuit board, and the liquid crystal panel is disposed on the backlight unit.

The liquid crystal display device provided by an embodiment of the present invention further comprises the first notch is located on a position corresponding to a position of the second notch; the first lateral side has a plurality of the first notches, and the second lateral side has a plurality of the second notches; and the first lateral side and the second lateral side through the first notch and the second notch respectively form a first wing piece and a second wing piece, and the length of the first wing piece is equal to the length of the second wing piece. The liquid crystal display device further comprises an optical film.

The embodiment of the present invention has an advantageous effect in that it can reduce the material cost of circuit board and improve the heat dissipation efficiency of circuit board by the notches of the first lateral side and the second lateral side of the circuit board.

### BRIEF DESCRIPTION OF THE DRAWINGS

FIG. 1 illustrates a conventional L-shaped circuit board.

FIG. 2 illustrates a fabricating a printed circuit board structure of a backlight unit according to an embodiment of the present invention.

FIG. 3 illustrates a printed circuit board structure of a backlight unit according to an embodiment of the present invention.

FIG. 4 illustrates light emitted diodes disposed on the printed circuit board structure of the backlight unit of FIG. 3.

FIG. 5 illustrates the printed circuit board structure of the backlight unit of FIG. 3 applied to a backlight unit of a liquid crystal display device.

FIG. 6 illustrates a heat dissipation comparison diagram of a circuit board of a backlight unit according to an embodiment of the present invention with a conventional circuit board.

### DETAILED DESCRIPTION OF THE INVENTION

Now, the preferred embodiment of the present invention will be described in detail with reference to the accompanying drawings.

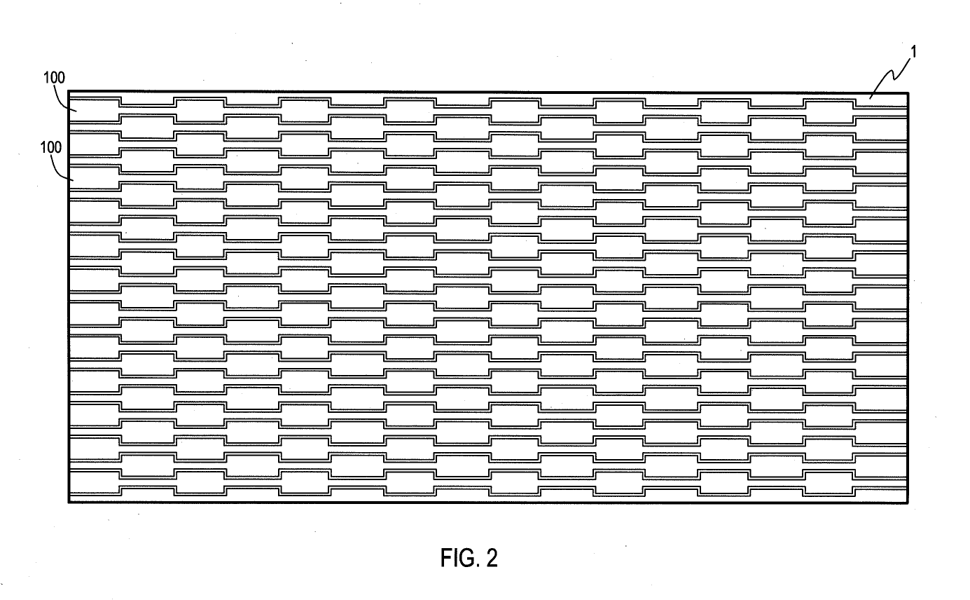

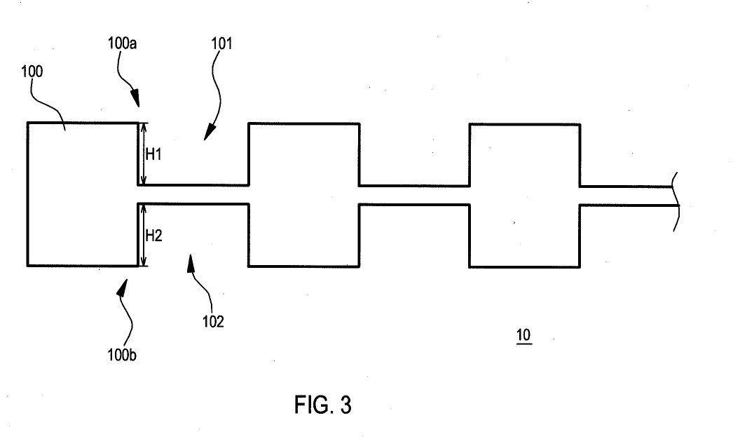

Referred to FIG. 2 and FIG. 3, FIG. 2 illustrates a fabricating a printed circuit board structure of a backlight unit according to an embodiment of the present invention; FIG. 3 illustrates a printed circuit board structure of a backlight unit according to an embodiment of the present invention.

As shown in FIG. 3, a printed circuit board structure 10 of a backlight unit (hereafter to be referred as a printed circuit board structure 10) comprises a circuit board 100. The circuit board 100 has a first lateral side 100a and a second lateral side 100b corresponding to the first lateral side 100a, wherein the first lateral side 100a has a plurality of first notches 101 and the second lateral side 100b has a plurality of second notches 102. As shown in FIG. 2, the circuit board 100 can be obtained by cutting a circuit board panel 1 along a predetermined cutting path to form the circuit board 100, but not limited herein.

It will be seen from this that, the first lateral side 100a and the second lateral side 100b respectively form a first wing piece and a second wing piece by the first notches 101 and the second notches 102, and a length H1 of the first wing piece is equal to a length H2 of the second wing piece, but not limited herein.

More specifically, the first notch 101 is located on a position corresponding to a position of the second notch 102, and the first lateral side 100a has a plurality of the first notches 101, and the second lateral side 100b has a plurality of the second notches 102.

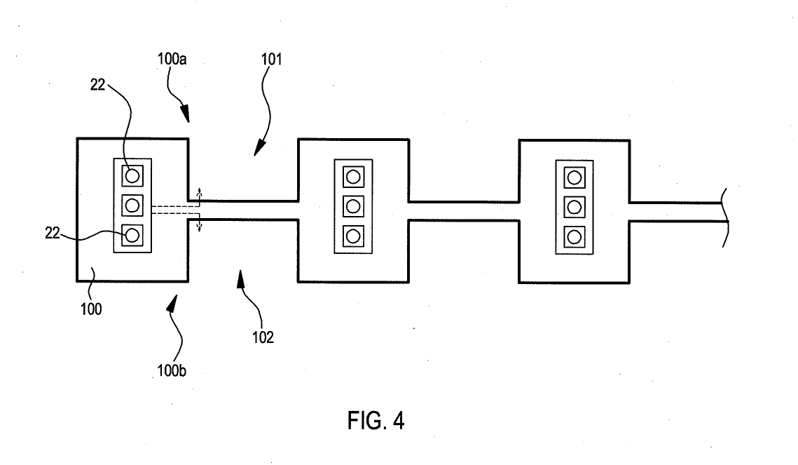

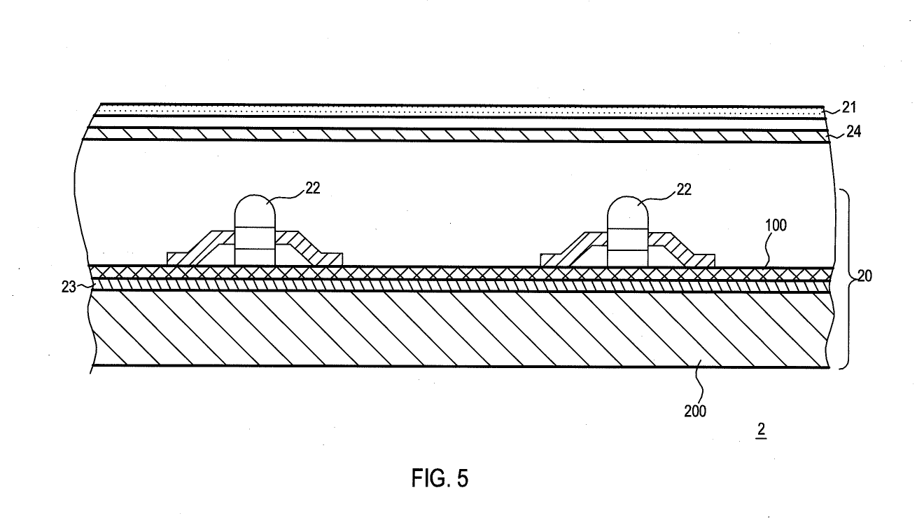

Referred to FIG. 3, FIG. 4 and FIG. 5, FIG. 4 illustrates a light emitted diode disposed on the printed circuit board structure of the backlight unit of FIG. 3; FIG. 5 illustrates the printed circuit board structure of the backlight unit of FIG. 3 applied to a backlight unit of a liquid crystal display device.

A liquid crystal display device 2 comprises a backlight unit 20 and a liquid crystal panel 21. The backlight unit 20 may be a direct type backlight unit, which comprises a back plate 200, a circuit board 100 and a plurality of light emitted diodes (LEDs) 22, wherein the circuit board 100 is disposed on the back plate 200, those LEDs 22 are disposed on a surface of the circuit board 100, the liquid crystal panel 21 is disposed on the backlight unit 20. Preferably, the backlight unit 20 further has a heat conducting material 23 disposed between the circuit board 100 and the back plate 200. The liquid crystal display device 2 further comprises an optical film 24. The optical film 24 comprises a diffuser, a prism sheet or a brightness enhancement film (BEF), but not limited to herein.

As shown in FIG. 4, the thermal energy (as shown at the arrow) generated by LEDs 22 can be directly dissipated through the first notch 101 and the second notch 102 of the circuit board 100 and can be conducted to the back plate 200 through the heat conducting material 23 for dissipating thermal energy. However, the above-mentioned descriptions and the structures shown on the figurations are only used for explanation purposes for easy understanding the technical features of the present invention, but not limited to the present invention.

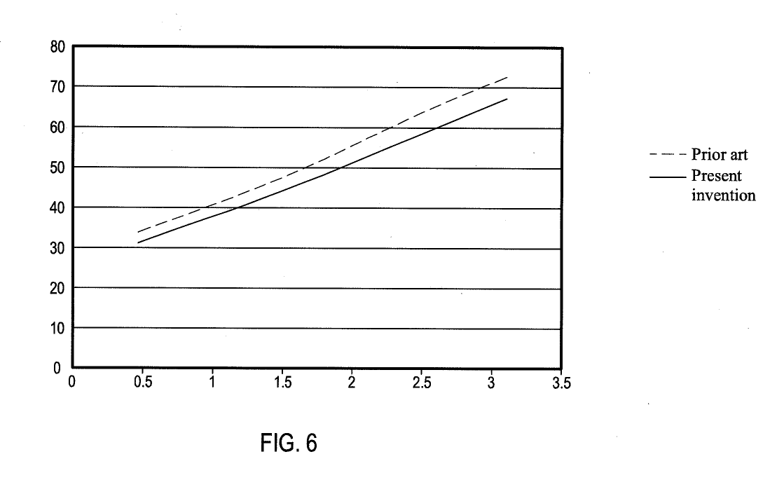

FIG. 6 illustrates a heat dissipation comparison diagram of a circuit board of a backlight unit according to an embodiment of the present invention with a conventional circuit board.

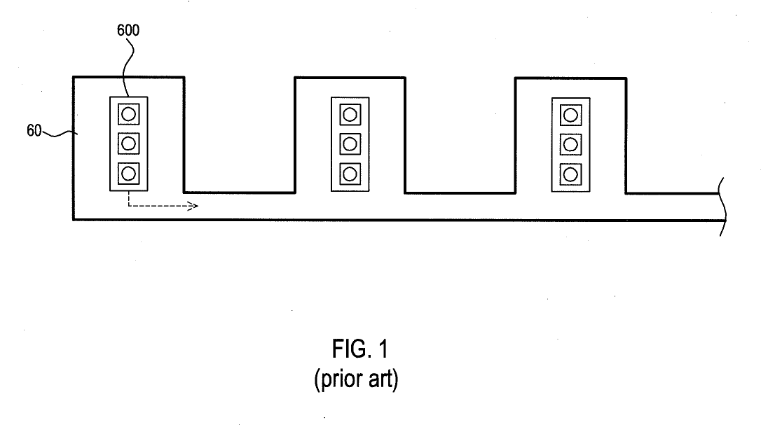

As shown in FIG. 6, the heat dissipation of LEDs 22 is improved effectively after LEDs 22 are disposed on the circuit board 100 of the printed circuit board structure 10 of the backlight unit of FIG. 3 and FIG. 4. For instance, when a power of LEDs is 0.5 w, a temperature of a pad on which LEDs are disposed is about 31° C. on the circuit board 100 (as shown in FIG. 4), but a temperature of a pad on which LEDs are disposed is about 33° C. on the conventional circuit board 60 (as shown in FIG. 1).

It will be seen from this that the circuit board 10 provided by the present invention can improve heat dissipation efficiency. In addition, the material cost of circuit board 100 can be reduced due to the notches of the first lateral side 100a and the second lateral side 100b of the circuit board 100.

As the foregoing, the printed circuit board structure, the backlight unit, and the liquid crystal display device using the same provided by the present invention have advantage as follows:

1. A cutting ratio of printed circuit board structure can be increased due to unequal width. That is, the cutting number of the circuit board can be a maximum amount from cutting a circuit board panel such that the material cost of circuit board can be reduced. Furthermore, the material cost of circuit board can be reduced due to the notches of the first lateral side and the second lateral side of circuit board.

2. The heat dissipation of circuit board can be increased due to the unequal width design.

The previous description of the preferred embodiment is provided to further describe the present invention, not intended to limit the present invention. Any modification apparent to those skilled in the art according to the disclosure within the scope will be construed as being included in the present invention.

What is claimed is:

1. A printed circuit board structure of a backlight unit, comprising:
a circuit board, having a first lateral side and a second lateral side corresponding to the first lateral side, wherein the first lateral side has a plurality of first notches and the second lateral side has a plurality of second notches, positions of the first notches are corresponding to positions of the second notches, the first lateral side and the second lateral side are respectively formed a first wing piece and a second wing piece by the first notch and the second notch, and a length of the first wing piece is equal to a length of the second wing piece.

2. A printed circuit board structure of a backlight unit, comprising:
a circuit board, having a first lateral side and a second lateral side corresponding to the first lateral side, wherein the first lateral side has a first notch and the second lateral side has a second notch.

3. The printed circuit board structure of a backlight unit, of claim 2, wherein the first notch is located on a position corresponding to a position of the second notch.

4. The printed circuit board structure of a backlight unit, of claim 2, wherein the first notch is plural notches and the second notch is plural notches.

5. The printed circuit board structure of a backlight unit, of claim 2, wherein the first lateral side and the second lateral side are respectively formed a first wing piece and a second wing piece by the first notch and the second notch, a length of the first wing piece is equal to a length of the second wing piece.

6. A backlight unit, comprising:
a back plate;
a circuit board, disposed on the back plate, wherein the circuit board has a first lateral side and a second lateral side corresponding to the first lateral side, the first lateral side has a first notch, and the second lateral side has a second notch; and
a plurality of light emitted diodes, disposed on a surface of the circuit board.

7. The backlight unit of claim 6, wherein the first notch is located on a position corresponding to a position of the second notch.

8. The backlight unit of claim 6, wherein the first notch is plural notches and the second notch is plural notches.

9. The backlight unit of claim 6, wherein the first lateral side and the second lateral side are respectively formed with a first wing piece and a second wing piece by the first notch and the second notch, and a length of the first wing piece is equal to a length of the second wing piece.

10. A liquid crystal display device, comprising:
a backlight unit, comprising:
a back plate;
a circuit board, disposed on the back plate, wherein the circuit board has a first lateral side and a second lateral side corresponding to the first lateral side, the first lateral side has a first notch, and the lateral side has a second notch; and
a plurality of light emitted diodes, disposed on a surface of the circuit board; and
a liquid crystal panel, disposed on the backlight unit.

11. The liquid crystal display device of claim 10, wherein the first notch is located on a position corresponding to a position of the second notch.

12. The liquid crystal display device of claim 10, wherein the first notch is plural notches and the second notch is plural notches.

13. The liquid crystal display device of claim 10, wherein the first lateral side and the second lateral side are respectively formed with a first wing piece and a second wing piece by the first notch and the second notch, and a length of the wing piece is equal to a length of the wing piece.

14. The liquid crystal display device of claim 10, wherein the liquid crystal display device further comprises an optical film.
